(19) United States
(12) Patent Application Publication
(10) Pub. No.: US 2013/0124687 A1
(43) Pub. Date: May 16, 2013

(54) APPARATUS AND METHOD FOR DETECTING MODIFIED UNIFORM RESOURCE LOCATOR

(71) Applicants: Dong-Su NAM, Seoul (KR); Nam-Deok CHO, Seoul (KR); Hyoung-Chun KIM, Seoul (KR); Sang-Woo PARK, Daejeon (KR); E-Joong YOON, Daejeon (KR)

(72) Inventors: Dong-Su NAM, Seoul (KR); Nam-Deok CHO, Seoul (KR); Hyoung-Chun KIM, Seoul (KR); Sang-Woo PARK, Daejeon (KR); E-Joong YOON, Daejeon (KR)

(73) Assignee: ELECTRONICS AND TELECOMMUNICATIONS RESEARCH INSTITUTE, Daejeon (KR)

(21) Appl. No.: 13/549,677

(22) Filed: Jul. 16, 2012

(30) Foreign Application Priority Data
Nov. 15, 2011 (KR) 10-2011-0119112

(51) Int. Cl. G06F 15/16

(52) U.S. Cl. 709/218

(57) ABSTRACT

An apparatus and method for detecting altered Uniform Resource Locators (URLs) are provided. The apparatus includes a Uniform Resource Locator (URL) information collection unit, a URL HTTP header analysis unit, a URL alteration determination unit, and a control unit. The URL information collection unit collects linked URL information in a web page selected by a user, from a web site. The URL HTTP header analysis unit analyzes the HTTP header information of the URL information. If, as a result of the analysis of the HTTP header information, information about redirection from the URL of the URL information to another URL exists, the URL alteration determination unit determines that the URL is an altered URL. If it is determined that the URL is an altered URL, the control unit extracts the URL information of the URL prior to the alteration and then provides the URL information to the user.

### CROSS REFERENCE TO RELATED APPLICATION

This application claims the benefit of Korean Patent Application No. 10-2011-0119112, filed on Nov. 15, 2011, which is hereby incorporated by reference in its entirety into this application.

### BACKGROUND OF THE INVENTION

1. Technical Field

The present invention relates generally to an apparatus and method for detecting altered URLs, and, more particularly, to an apparatus and method for detecting altered URLs, which are capable of checking whether a Uniform Resource Locator (URL) has been altered in a web page of a web site accessed without having undergone a specific previous registration procedure, and which are capable of detecting a URL prior to its alteration.

2. Description of the Related Art

Recently, because the number of Social Networking Services (SNSs) is increasing, the numbers of infections with malicious code and threats to security using altered URLs are increasing.

By way of example, an altered URL which was connected to a phishing site was spread via Twitter Direct Messages (DMs), an altered URL which induces a moving image malicious codec to be installed was spread via Facebook DMs, and altered URLs of Google which spread malicious vaccines were spread.

In order to solve such problems, schemes for preventing altered URLs from spreading are being established. “PSMS Design and Implementation for Phishing Attack Intercept” in the Journal of Information and Security published in March 2008 discloses technology in which in order to enhance the exchange of information because of rapid changes in a web environment, a proxy server is installed on a network between a web server and a client, so that malicious web sites are analyzed and phishing URLs are filtered out by comparing them with a white domain list, thereby ensuring the stable web-based exchange of information.

However, in the preceding paper, in order to determine whether a specific web site accessed by a user is a secure web site, a white domain list previously registered in a database is compared and analyzed, service is provided only to specific altered URL sites previously registered in and put into the DB, and a corresponding plug-in does not operate in some web browsers.

### SUMMARY OF THE INVENTION

Accordingly, the present invention has been made keeping in mind the above problems occurring in the prior art, and an object of the present invention is to provide an apparatus and method for detecting altered URLs, which are capable of, before accessing a URL which may have been altered, detecting the alteration of URLs and then eliminating the risk of a malicious site being connected to without the consent of a user.

In order to accomplish the above object, the present invention provides an apparatus for detecting altered Uniform Resource Locators (URLs), including a Uniform Resource Locator (URL) information collection unit for, when accessing a web site, collecting linked URL information in a web page selected by a user, from the web site; a URL HTTP header analysis unit for analyzing HyperText Transfer Protocol (HTTP) header information of the URL information collected by the URL information collection unit; a URL alteration determination unit for, if, as a result of the analysis of the HTTP header information by the URL HTTP header analysis unit, information about redirection from a URL of the URL information to another URL exists, determining that the URL is an altered URL; and a control unit for, if it is determined by the URL alteration determination unit that the URL is an altered URL, extracting URL information of an original URL corresponding to the redirection and then providing the URL information to the user.

In this case, the original URL may correspond to final destination of the redirection. The original URL may correspond to the URL prior to alteration. The original URL may correspond to the URL which is redirected from the altered URL.

If, as a result of the analysis of the HTTP header information, information about redirection from the URL to another URL exists, the URL information prior to the alteration may be information about the other URL.

The URL information collection unit may collect linked URL information from the web page at a location where a pointer is placed.

The pointer may be a mouse pointer. The pointer may be a cursor.

The URL information collection unit may collect linked URL information at the corresponding location whenever the location of the pointer is moved across the web page by the manipulation of an input interface of the user.

The URL information collection unit may collect linked URL information in a corresponding web page whenever the web page is changed to the corresponding web page.

The URL information collection unit may collect linked URL information in a selected web page when a new web site is accessed.

When a location of a pointer is moved by manipulation of an input interface of the user, the control unit may provide URL information of a linked URL prior to alteration at a location where the pointer is placed, and provides the URL information to the user.

In order to accomplish the above object, the present invention provides a method of detecting altered URLs, including, when accessing a web site, collecting linked URL information in a web page selected by the user from the web site; analyzing HyperText Transfer Protocol (HTTP) header information based on the URL information collected when collecting the URL information; if, as a result of the analysis of the HTTP header information, information about redirection from the URL to another URL exists, determining that the URL is an altered URL; and if it is determined that the URL is an altered URL, extracting URL information of an original URL corresponding to the redirection and then providing it to the user.

In this case, the original URL may correspond to final destination of the redirection. The original URL may correspond to the URL prior to alteration. The original URL may correspond to the URL which is redirected from the altered URL.

If, as a result of the analysis of the HTTP header information, information about redirection from the URL to the other URL exists, the URL information prior to its alteration may be the other URL information.

The collecting may include collecting linked URL information from the web page at a location where the pointer is placed.

The collecting may include collecting linked URL information from the web page at a corresponding location whenever the location of the pointer is moved by manipulation of an input interface of the user.

The collecting URL information may include collecting linked URL information from a corresponding web page whenever the web page is changed to the corresponding web page.

The collecting may include collecting linked URL information from a selected web page whenever a new web site is accessed.

The providing may include, when the location of a pointer is moved by the manipulation of the input interface of the user, extracting URL information of linked URL prior to alteration at a location where the pointer is placed, and then providing the URL information to the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram to which reference is made to describe the configuration of an apparatus for detecting altered URLs according to the present invention;

FIG. 2 is a diagram showing an example of an apparatus for detecting altered URLs according to an embodiment of the present invention;

FIG. 3 is a diagram showing an example of an apparatus for detecting altered URLs according to another embodiment of the present invention; and

FIG. 4 is a flowchart illustrating the flow of the operations of the method of detecting altered URLs according to the present invention operation.

### DESCRIPTION OF THE PREFERRED EMBODIMENTS

Reference now should be made to the drawings, throughout which the same reference numerals are used to designate the same or similar components.

Embodiments of the present invention will be described below with reference to the accompanying drawings.

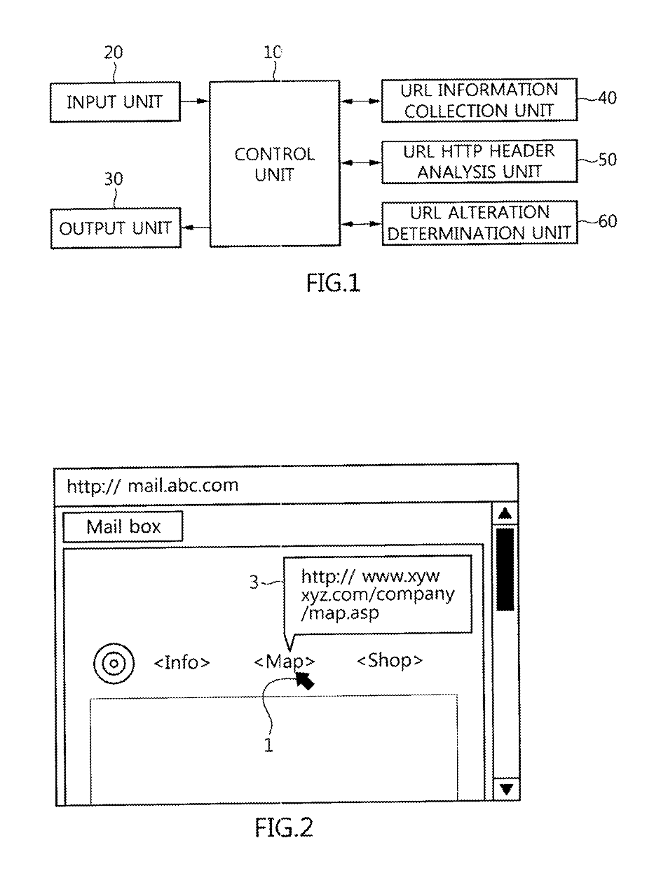

FIG. 1 is a block diagram to which reference is made to describe the configuration of an apparatus for detecting altered URLs (spoofed URLs) according to the present invention.

FIG. 1 as shown in, an apparatus for detecting altered URLs according to the present invention includes a control unit 10, an input unit 20, an output unit 30, a URL information collection unit 40, a URL HTTP header analysis unit 50, and a URL alteration determination unit 60. Here, the control unit 10 controls the components of the apparatus for detecting altered URLs.

The input unit 20 receives signals corresponding to the manipulation of an input interface from a user. For example, when the user manipulates a touch screen or a mouse, a pointer (cursor) location movement signal, a button click signal and the like are input.

The output unit 30 provides the control signals of the control unit 10 to the output interface of a user terminal. For example, the output unit 30 provides the operating status and processing results of the apparatus for detecting altered URLs to the output interface of the user terminal. Here, the output interface corresponds to a monitor, a touch screen or the like.

The URL information collection unit 40 collects linked URL information in a web page selected by the user, from an accessed web site once a web browser is run in the user terminal and the web site corresponding to an URL entered by a user is accessed.

Here, the URL information collection unit 40 collects linked URL information at a location where a pointer is placed on the screen of a web page of a web site. It will be apparent that when the location of the pointer is moved across the screen of the corresponding web page by the manipulation of the input interface of the user, the URL information collection unit 40 collects information about a linked URL at a corresponding location whenever the location of the pointer is moved across the screen of the web page.

Meanwhile, when another web page of the corresponding web site is accessed by the selection of a specific item on he current web page by the user, the URL information collection unit 40 collects linked URL information in the corresponding web page whenever the web page being accessed is changed to another web page.

Furthermore, the URL information collection unit 40 collects linked URL information in a web page of a newly accessed web site when the new web site is accessed in response to a request from the user. It will be apparent that when another web site is accessed, the URL information collection unit 40 collects linked URL information linked in a selected web page in the corresponding web site.

Once the URL information has been collected by the URL information collection unit 40, the URL HTTP header analysis unit 50 analyzes HTTP header information based on the collected URL information.

Here, HTTP is short for HyperText Transfer Protocol, and is an application layer protocol designed for the purpose of developing a hypermedia information system which will be used in a distributed environment and a collaborative work environment. Here, HTTP is used to transmit hypertext document, audio, video, data, etc. over the World Wide Web (WWW), and provides service based on a request/response, i.e., stateless operation.

An HTTP header includes URL transmission information and information about redirection from one URL to another.

The URL alteration determination unit 60 determines that a corresponding URL is not an altered URL if, as a result of the analysis of the HTTP header information by the URL HTTP header analysis unit 50, it is determined that information about redirection from the corresponding URL to another URL does not exist in the HTTP header. Meanwhile, the URL alteration determination unit 60 determines that the corresponding URL is an altered URL if, as a result of the analysis of the HTTP header information by the URL HTTP header analysis unit 50, it is determined that the information about redirection from the corresponding URL to another URL exists in the HTTP header.

Once it is determined by the URL alteration determination unit 60 that the corresponding URL is an altered URL, the control unit 10 extracts URL information prior to the alteration of the URL, and outputs the extracted URL information via the output unit 30. In this case, the output unit 30 outputs the URL information prior to the alteration from the control unit 10 to the output interface of the user terminal, thereby providing the URL information prior to the alteration to the user.

Here, if, as a result of the analysis of the HTTP header of the URL, the information about redirection from the corresponding URL to another URL exists in the HTTP header, the information about another URL is the URL information prior to alteration.

In this case, when the location of a pointer has been moved by the manipulation of the input interface of the user, the control unit 10 extracts the URL information of a linked URL prior to alteration at a location where the pointer is moved and placed, and outputs it via the output unit 30.

Accordingly, the output unit 30 outputs the URL information prior to the alteration, transferred from the control unit 10, to the output interface of the user terminal, thereby providing the URL information prior to the alteration to the user.

FIG. 2 is a diagram showing an example of an apparatus for detecting altered URLs according to an embodiment of the present invention, which illustrates an embodiment in the case where a linked URL in a web page of an accessed web site is not an altered URL.

As shown in FIG. 2, a user moves a pointer 1 across the screen of a web page by manipulating the input interface of a user terminal. The pointer may be a mouse pointer. The pointer may be a cursor.

When the pointer 1 is placed on an item of the web page by manipulating the input interface, the apparatus for detecting altered URLs collects linked URL information at the location where the corresponding pointer 1 is placed. In this case, it is determined whether the collected URL is an altered URL, and, if the collected URL is not an altered URL, the collected URL is displayed on the screen of the web page.

For example, when the pointer 1 is placed on a <Map> item in a web page of an accessed web site, the apparatus for detecting altered URLs collects the linked URL “http:/www.xywxyz.com/company/map.asp” 3 at a location where the corresponding pointer 1 is located, and causes the linked URL to be displayed on the screen of the web page.

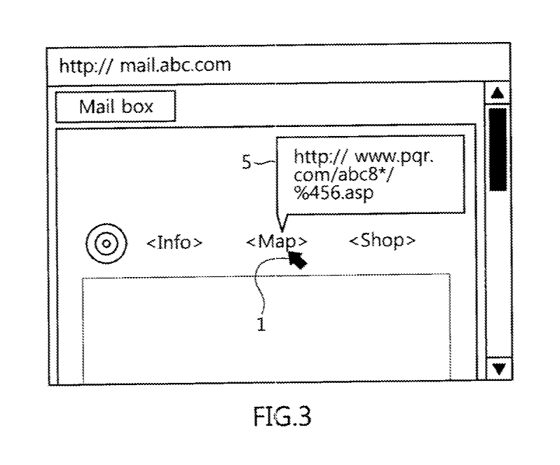

FIG. 3 is a diagram showing an example of an apparatus for detecting altered URLs (modified URLs, spoofed URLs) according to another embodiment of the present invention, and illustrates an embodiment in the case where a linked URL in a web page of an accessed web site is an altered URL.

As shown in FIG. 3, a user moves the pointer 1 across the screen of a web page by manipulating the input interface of a user terminal.

When the pointer 1 is placed on an item of a web page by manipulating the input interface, the apparatus for detecting altered URLs collects linked URL information at a location where the corresponding pointer 1 is placed. In this case, it is determined whether the collected URL is an altered URL, and, if the collected URL is an altered URL, URL information of an original URL is extracted from an HTTP header and is displayed on the screen of the web page.

In this case, the original URL may correspond to final destination of the redirection. The original URL may correspond to the URL prior to alteration. The original URL may correspond to the URL which is redirected from the altered URL.

For example, when the pointer 1 is placed on a <Map> item in a web page of an accessed web site, the apparatus for detecting altered URLs extracts the URL prior to the alteration “http://www.pqr.com/abc8*/%456.asp” 5 of a linked URL at the location where the corresponding pointer 1 is located, and causes the URL prior to the alteration to be displayed on the screen of the web page.

Although FIGS. 2 and 3 illustrate the examples in which a not altered URL and the URL information of an altered URL prior to alteration are indicated in the form of speech bubbles, the present invention is not limited to any one embodiment, but URL information may be indicated on a status bar in the bottom of a page.

A method of detecting altered URLs according to the present invention will now be described.

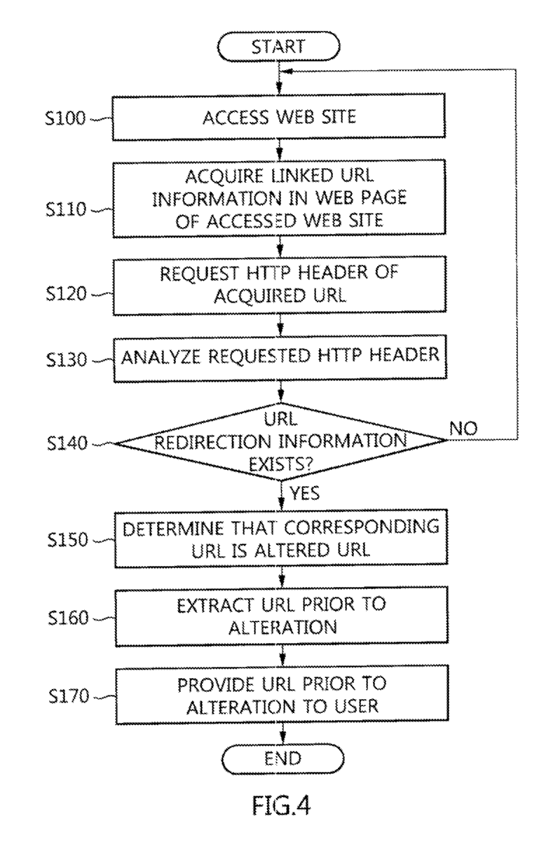

FIG. 4 is a flowchart illustrating the flow of the operations of the method of detecting altered URLs according to the present invention operation.

As shown in FIG. 4, when a web browser is run in the user terminal and a web site corresponding to a URL entered by a user is accessed at step S100, the apparatus for detecting altered URLs according to the present invention obtains linked URL information linked in a web page, selected by the user, from the accessed web site at step S110.

Here, the apparatus for detecting altered URLs collects linked URL information at a location where the pointer is placed on the screen of the web page of the accessed web site. It will be apparent that when the location of the pointer is moved across the screen of the corresponding web page by the manipulation of the input interface of the user, the URL information collection unit 40 collects linked URL information at a corresponding location whenever the location of the pointer is moved across the screen of the web page.

Furthermore, when another web page of the corresponding web site is accessed by the selection of a specific item of the user from the current web page, or when a new web site is accessed, linked URL information in the newly accessed web page or a web page of the newly accessed web site is collected.

Thereafter, the apparatus for detecting altered URLs requests the HTTP header information of the linked URL information, acquired at step S110, S120, and analyzes it at step S130.

If, as a result of the analysis of the HTTP header information at step S130, it is determined at step S140 that information about redirection from the corresponding URL to another URL does not exist in the HTTP header, the process returns to step S100, where the process which is performed after the pointer is moved across the screen is performed again.

Meanwhile, if, as a result of the analysis of the HTTP header information at step S130, it is determined at step S140 that the information about redirection from the corresponding URL to another URL exists in the HTTP header, it is determined that the corresponding URL is an altered URL at step S150, and the URL information of the corresponding URL prior to alteration is extracted from an HTTP header at step S160.

In this case, the corresponding URL prior to alteration may be the original URL.

Here, if, as a result of the analysis of the HTTP header information of a URL, information about redirection from the corresponding URL to another URL exists in the HTTP header, the URL information prior to alteration is information about the another URL.

Accordingly, the apparatus for detecting altered URLs provides the URL information prior to alteration extracted at step S160 to the user at step S170.

The present invention is advantageous in that a user, before accessing a URL which may have been altered, can check whether a corresponding address has been altered and eliminate the risk of connecting to a malicious site without the consent of a user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for detecting altered Uniform Resource Locators (URLs), comprising:
a Uniform Resource Locator (URL) information collection unit for collecting linked URL information in a web page selected by a user, from a web site accessed by the user, a URL HTTP header analysis unit for analyzing HyperText Transfer Protocol (HTTP) header information of the linked URL information;
a URL alteration determination unit for determining that a URL corresponding to the linked URL information is an altered URL when the HTTP header information includes redirection information from the URL to another URL; and
a control unit for extracting URL information of an original URL corresponding to the redirection and then providing the URL information of the original URL to the user.

2. The apparatus as set forth in claim 1, wherein the URL information of the original URL is information about the other URL.

3. The apparatus as set forth in claim 1, wherein the URL information collection unit collects linked URL information from the web page at a location where a pointer is placed.

4. The apparatus as set forth in claim 3, wherein the URL information collection unit collects linked URL information at the corresponding location whenever a location of the pointer is moved across the web page by manipulation of an input interface of the user.

5. The apparatus as set forth in claim 1, wherein the URL information collection unit collects linked URL information in a corresponding web page whenever the web page is changed to the corresponding web page.

6. The apparatus as set forth in claim 1, wherein the URL information collection unit collects linked URL information in a selected web page when a new web site is accessed.

7. The apparatus as set forth in claim 1, wherein the control unit, when a location of a pointer is moved by manipulation of an input interface of the user, extracts URL information of the original URL at a location where the pointer is placed, and provides the URL information of the original URL to the user.

8. A method of detecting altered URLs, comprising:
collecting linked URL information in a web page selected by a user from a web site accessed by the user;
analyzing HyperText Transfer Protocol (HTTP) header information based on the linked URL information;
determining that a URL corresponding to the linked URL information is an altered URL when the HTTP header information includes redirection information from the URL to another URL; and
extracting URL information of an original URL corresponding to the redirection and then providing the URL information of the original URL to the user.

9. The apparatus as set forth in claim 8, wherein the URL information of the original URL is information about the other URL.

10. The apparatus as set forth in claim 8, wherein the collecting comprises collecting linked URL information from the web page at a location where a pointer is placed.

11. The apparatus as set forth in claim 10, wherein the collecting comprises collecting linked URL information from the web page at a corresponding location whenever the location of the pointer is moved by manipulation of an input interface of the user.

12. The apparatus as set forth in claim 8, wherein the collecting comprises collecting linked URL information from a corresponding web page whenever the web page is changed to the corresponding web page.

13. The apparatus as set forth in claim 8, wherein the collecting comprises collecting linked URL information from a selected web page whenever a new web site is accessed.

14. The apparatus as set forth in claim 8, wherein the extracting comprises, when a location of a pointer is moved by the manipulation of the input interface of the user, extracting URL information of the original URL at a location where the pointer is placed, and then providing the URL information of the original URL to the user.
